(19) United States
(12) Patent Application Publication
(10) Pub. No.: US 2026/0189976 A1
(43) Pub. Date: Jul. 2, 2026

(54) Flexible Buffer Status Reports in a Communication Network

(71) Applicant: GOOGLE LLC, Mountain View, CA (US)

(72) Inventor: Shiangrung Ye, Sanchong District, New Taipei City (TW)

(21) Appl. No.: 19/128,138

(22) PCT Filed: Nov. 7, 2023
(86) PCT No.: PCT/US2023/079021

§ 371 Date: May 7, 2025

Related U.S. Application Data
(60) Provisional application No. 63/382,721, filed on Nov. 7, 2022.

(51) Int. Cl. H04W 28/02

(52) U.S. Cl. CPC H04W 28/0278

(57) ABSTRACT

To report a buffer status, a user equipment (UE) receives, from a network, an indication of a format the UE is to use to report, to the network, a buffer size for a logical channel group (ECG). The UE generates, in accordance with the format, a report of the buffer size of the ECG, the report including (i) an indication of one of a plurality of buffer size tables, and (ii) an index in the one of the plurality of buffer size tables. The UE transmits transmits the report to the network.

### CROSS-REFERENCE TO RELATED APPLICATION

This application claims priority to and the benefit of the filing date of provisional U.S. Patent Application No. 63/382,721 entitled “Flexible Buffer Status Reports in a Communication Network,” filed on Nov. 7, 2022. The entire contents of the provisional application is hereby expressly incorporated herein by reference

### FIELD OF THE DISCLOSURE

This disclosure relates to wireless communications and, more particularly, to managing buffer status reports (BSRs) associated with extended Reality (XR), cloud gamming (CG), and other services that generally requires a high data rate.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Base stations that operate according to fifth-generation (5G) New Radio (NR) requirements support significantly larger bandwidth than fourth-generation (4G) base stations. In some cases, a base station can transmit to a user device, or a user equipment (UE), data associated with extended Reality (XR), which refers to such technologies as Augmented Reality (AR), Virtual Reality (VR), Mixed Reality (MR), cloud gaming. The technologies generally involve quasi-periodic streaming and are associated with high data rates and low-latency requirements.

Some of the challenges associated with supporting XR communications include the development of mechanisms that could provide a more efficient resource allocation and scheduling for XR service characteristics such as periodicity, multiple flows, jitter, latency, and reliability. These challenges also include efficient management of reporting of a buffer status, which a UE transmits to a base station when communicating a large amount of data.

According to the existing Medium Access Control (MAC) specification, a UE can transmit a BSR (Buffer Status Report) MAC control element (CE) to a base station. In the BSR, the UE sets an index that indicates a range of buffer sizes for a logical channel group (LCG). There is a maximum buffer size (BS) associated with each range of buffer sizes. For example, the buffer size table in FIG. 10 illustrates the mapping between an index and the corresponding range. As a more specific example, the index value of “7” maps to the range of buffer sizes that are smaller than or equal to 74 bytes.

There are so-called short, long, and extended long BSR formats a UE can use to transmit the index. The short BSR format (FIG. 11) allows the UE to report the buffer status for only one LCG. The long BSR format (FIG. 12) and extended long BSR format (FIG. 13) allow the UE to report respective buffer statuses for eight LCGs and 256 LCGs, respectively.

According to the long BSR format, each LCG is associated with a one-bit field (“LCG field”). The value of “1” in the LCG field indicates that the corresponding BS (buffer size) field is included in the BSR for the LCG. The UE sets the BS field to an index in a buffer size table. For example, if the UE needs to report the buffer status for LCG 0 and LCG 1, the UE can use the long BSR format and set the LCG0 field as well as the LCG1 field to “1.” These values indicate to the network that the UE has included BS fields for LCG0 and LCG1. The UE includes a BS field for LCG0 in the BSR MAC CE, followed by another BS field for LCG1. The value of the BS field is set to one of the indexes in the buffer size table. The UE includes BS fields in the same order as the LCG fields in the BSR MAC CE.

The maximum BS for each range is coded by an exponential function

$${B}_{k} = {B}_{min} \cdot {( 1 + p )}^{k} , where p = {( {B}_{max} / {B}_{min} )}^{1 / ( N - 1 )} - 1 ,$$

where Bmin is the minimum buffer size, Bmax is the maximum buffer size that a UE can report, N is the total number of code points (32 for short-BSR format and 256 for long BSR format). This formula provides proper granularity when k is small; however, the step size can grow exponentially as k increases. For example, at k=252, BS=76,380,419 bytes; at k=253, BS=81,338,368 bytes, which makes the step size 4,957,949 bytes. Thus, when the UE reports a buffer size of 81 MB, the actual buffer size may in fact be 4.9 MB smaller.

Further, when a base station receives a BSR MAC CE, the base station receives the max BS for an LCG. The base station is not aware of the actual buffer size for the LCG. Thus, when the base station allocates resources for a UE with the size corresponding to a certain maximum BS value, but the actual buffer size is less than this maximum BS value, the UE may need to add padding bytes. For example, if the actual buffer size is 5,000 bytes, and the UE reports an index 20 (i.e., max BS=5446 bytes) in the BSR MAC CE, the base station allocates resources to the UE for transmitting the 5446 bytes, and the UE accordingly needs to add 446 bytes padding bytes in the MAC PDU.

The wasteful use of padding bytes can be particularly severe when the UE reports a large buffer size, as the step size grows exponentially for the reasons discussed above. For example, the step size between index 10 (e.g. max BS=198) and index 11 (i.e. max BS=276) is 276−198=78. However, the step size between index 29 (e.g. max BS=107669) and index 30 (i.e. max BS=150000) is 150000−107669=42331.

For xR in particular, traffic typically includes video and audio, and so the UE may need to report a large buffer size. As a result, the base station can allocate excessive resources, which may have a detrimental effect on the overall xR capacity.

### SUMMARY

An example embodiment of these techniques is a method in a user equipment (UE) for reporting a buffer status. The method incudes receiving, at the UE from a network, an indication of a format the UE is to use to report, to the network, a buffer size for a logical channel group (LCG); generating, at the UE and in accordance with the format, a report of the buffer size of the LCG; and transmitting the report to the network. The report includes (i) an indication of one of a plurality of buffer size tables, and (ii) an index in the one of the plurality of buffer size tables.

Another example embodiment of these techniques is user equipment (UE) comprising a radio circuitry configured to support a radio interface; and a control circuitry configured to implement the method above.

Another example embodiment of these techniques is a method in a network for obtaining a buffer status of a UE. The method incudes transmitting, to a UE, an indication of a format the UE is to use to report, to the network, a buffer size for a logical channel group (LCG); and receiving, at the network from the UE, a report of the buffer size of the LCG, the UE generated in accordance with the format. The report includes (i) an indication of one of a plurality of buffer size tables, and (ii) an index in the one of the plurality of buffer size tables.

Still another example embodiment of these techniques is a network device including a radio circuitry configured to support a radio interface; and a control circuitry configured to implement the method above.

### BRIEF DESCRIPTION OF THE DRAWINGS

FIG. 1 is a block diagram of an example system in which a radio access network (RAN) and a user equipment (UE) can implement the techniques of this disclosure for flexible

FIG. 2 is a block diagram of an example protocol stack according to which the UE of FIG. 1 communicates with base stations;

FIG. 3 is a messaging diagram of an example scenario in which the UE generates and transmits a buffer status report (BSR) using one or more of the techniques of this disclosure;

FIG. 4 is a flow diagram of an example method for reporting the buffer size for a certain logical channel group (LCG) using the size of the field indicated by the network;

FIG. 5 illustrates an example format of the report, which the UE generates according to the method of FIG. 4;

FIG. 6 is a flow diagram of an example method for reporting the buffer size for a certain LCG using one subfield to reference a particular buffer size table, and another subfield to reference a particular entry in the table;

FIGS. 7A and 7B illustrate example formats of the report, which the UE generates according to the method of FIG. 6;

FIG. 8 is a flow diagram of an example method for reporting the buffer size for a certain LCG using multiple subfields to reference respective entries in the buffer size table, where the desired buffer size is a function of the two entries;

FIGS. 9A-C illustrate example formats of the report, which the UE generates according to the method of FIG. 8;

FIG. 10 illustrates an example 5-bit buffer size table;

FIGS. 11-13 illustrate several known BSR formats; and

FIG. 14 illustrates an example 8-bit BSR format.

### DETAILED DESCRIPTION OF THE DRAWINGS

The flexible buffer status reporting techniques of this disclosure allow a UE to generate a BSR with more granularity and accuracy. The UE can implement one or more of the following example features: (i) negotiating, with the network, a larger field for reporting the buffer size for a certain LCG, (ii) using the fields allocated for other LCG unused by the UE, (iii) using indexes to multiple buffer size tables, and (iv) combining maximum BS values to specify sub-step sizes.

In some cases, a UE can use additional bits (e.g., 16, 32 bits) relative to the default number of bits in a corresponding information element, which the network allocates per LCG in at least some of the implementations, to report the buffer status for a certain LCG. The UE and the network can thereby use a larger set of different buffer sizes to improve the granularity of buffer size reporting and, accordingly, the xR capacity.

In some scenarios, using more bits to report the buffer status results in a signaling overhead. A UE accordingly can use fewer bits (e.g., eight) to report the buffer status for an LCG with a low data rate. For an LCG with a high data rate, the UE can more bits to report buffer status. Rather than using the same size of the BS field to report respective buffer statuses for different LCGs, the UE can use a different number of bits (e.g. 8, 16, 32) to report the buffer status for different LCGs within the same BSR MAC CE. Moreover, in some implementations, the UE and the network use more than one buffer size table, and the UE specifies both the buffer size table and an entry within the specified buffer size table, for an LCG.

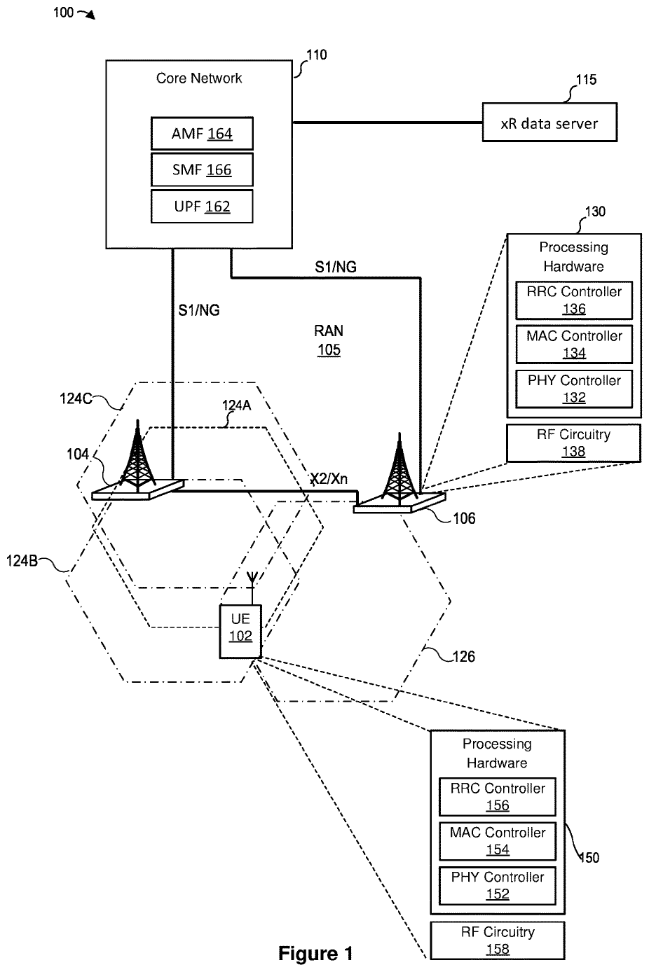

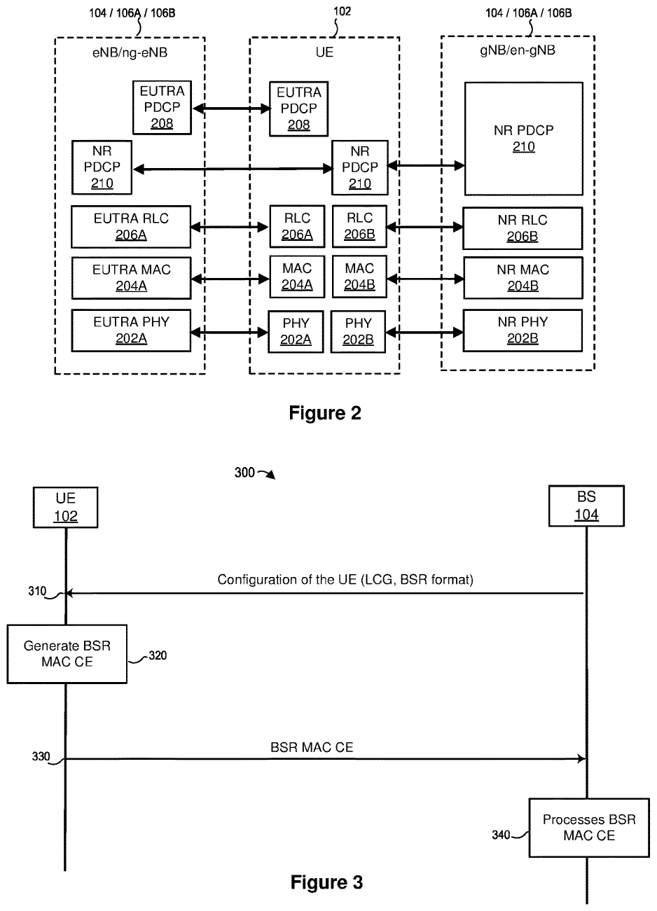

These techniques are discussed in more detail below with reference to FIGS. 3-9C, which follows a brief discussion of an example communication system and a protocol stack with reference to FIGS. 1 and 2. In this discussion, the term “network” can refer to the radio access network (RAN) and/or the core network (CN).

FIG. 1 depicts an example wireless communication system 100 in which a communication devices can use flexible buffer size reporting techniques. The wireless communication system 100 includes a UE 102, a base station (BS) 104, a base station 106 and a core network (CN) 110. The UE 102 initially connects to the base station 104. In some scenarios, the base station 104 can perform an SN addition to configure the UE 102 to operate in dual connectivity (DC) with the base station 104 and the base station 106. The base stations 104 and 106 operate as an MN and an SN for the UE 102, respectively.

A core network (CN) 110 can be for example a fifth-generation core (5GC). The base station 104 can be an eNB supporting an S1 interface for communicating with the CN 110 implemented as an EPC, an ng-eNB supporting an NG interface for communicating with the CN 110 implemented as a 5GC, or a gNB that supports an NR radio interface as well as an NG interface for communicating with the CN 110 implemented as a 5GC. To directly exchange messages with each other during the scenarios discussed below, the base stations 104 and 106 can support an X2 or Xn interface. The CN 110 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1, the base station 104 supports cell 124A, and the base station 106 supports a cell 126. The cells 124A and 126 can partially overlap, so that the UE 102 can communicate with the base station 104 and/or the base station 106 in multiple connectivity scenarios, handover scenarios, etc. The base station 104 can support additional cell(s) such as cells 124B and 124C, and the base station 106 can support additional cell(s) (not shown in FIG. 1A). The cells 124A, 124B and 124C can partially overlap, so that the UE 102 can communicate in carrier aggregation (CA) with the base station 104.

In general, the wireless communication network 100 can include any suitable number of base stations supporting NR cells or cells that implement other RATs such as EUTRA. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

With continued reference to FIG. 1, each of the base stations 104 and 106 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 can include a PHY controller 132 configured to transmit data and control signal on physical downlink (DL) channels and DL reference signals with one or more user devices (e.g. UE 102) via one or more cells (e.g., the cell(s) 124A, 124B and/or 124C) and/or one or more TRPs. The PHY controller 132 is also configured to receive data and control signal on physical uplink (UL) channels and/or UL reference signals with the one or more user devices via one or more cells (e.g., the cell(s) 124A, 124B and/or 124C) and/or one or more TRPs. The processing hardware 130 in an example implementation includes a MAC controller 134 configured to perform MAC functions with one or more user devices. The MAC functions includes a random access (RA) procedure, managing UL timing advance for the one or more user devices, and/or communicating UL/DL MAC PDUs with the one or more user devices. The processing hardware 130 can further include an RRC controller 136 to implement procedures and messaging at the RRC sublayer of the protocol communication stack. For example, the RRC controller 132 may be configured to support RRC messaging associated with handover procedures, and/or to support the necessary operations when the base station 104 operates as an MN relative to an SN or as an SN relative to an MN.

Each of the base stations 104 and 106 is further equipped with RF circuitry 138 that can include any suitable number of antennas and electronic components for supporting the radio interface at the physical layer.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The PHY controller 152 is also configured to receive data and control signal on physical DL channels and/or DL reference signals with the base station 104 or 106 via one or more cells (e.g., the cell(s) 124A, 124B, 124C and/or 126) and/or one or more TRPs. The PHY controller 152 is also configured to transmit data and control signal on physical UL channels and/or UL reference signals with the base station 104 or 106 via one or more cells (e.g., the cell(s) 124A, 124B, 124C and/or 126) and/or one or more TRPs. The processing hardware 150 in an example implementation includes a MAC controller 154 configured to perform MAC functions with base station 104 or 106. For example, the MAC functions includes a random access procedure, managing UL timing advance for the one or more user devices, and communicating UL/DL MAC PDUs with the base station 104 or 106. The processing hardware 150 can further include an RRC controller 156 to implement procedures and messaging at the RRC sublayer of the protocol communication stack. Similar to the base stations 104 and 106, the UE 102 is equipped with RF circuitry 158 that can include any suitable number of antennas and electronic components for supporting the radio interface at the physical layer.

Next, FIG. 2 illustrates in a simplified manner a radio protocol stack according to which the UE 102 can communicate with an eNB/ng-eNB or a gNB. Each of the base stations 104 or 106 can be the eNB/ng-eNB or the gNB.

The physical layer (PHY) 202A of EUTRA provides transport channels to the EUTRA Medium Access Control (MAC) sublayer 204A, which in turn provides logical channels to the EUTRA Radio Link Control (RLC) sublayer 206A, and the EUTRA RLC sublayer in turn provides RLC channels to the EUTRA PDCP sublayer 208 and, in some cases, NR PDCP sublayer 210. Similarly, the PHY 202B of NR provides transport channels to the NR MAC sublayer 204B, which in turn provides logical channels to the NR RLC sublayer 206B, and the NR RLC sublayer 206B in turn provides RLC channels to the NR PDCP sublayer 210. The UE 102 in some implementations supports both the EUTRA and the NR stack, to support handover between EUTRA and NR base stations and/or DC over EUTRA and NR interfaces. Further, as illustrated in FIG. 2A, the UE 102 can support layering of NR PDCP 210 over EUTRA RLC 206A.

The EUTRA PDCP sublayer 208 and the NR PDCP sublayer 210 receive packets (e.g., from the Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 provide SRBs to exchange Radio Resource Control (RRC) messages, for example. On a user plane, the EUTRA PDCP sublayer 208 and the NR PDCP sublayer 210 provide DRBs to support data exchange.

When the UE 102 operates in EUTRA/NR DC (EN-DC), with the base station 104 operating as a MeNB and the base station 106 operating as a SgNB, the network can provide the UE 102 with an MN-terminated bearer that uses EUTRA PDCP 208 or MN-terminated bearer that uses NR PDCP 210. The network in various scenarios also can provide the UE 102 with an SN-terminated bearer, which use only NR PDCP 210. The MN-terminated bearer can be an MCG bearer or a split bearer. The SN-terminated bearer can be a SCG bearer or a split bearer. The MN-terminated bearer can be an SRB (e.g., SRB1 or SRB2) or a DRB. The SN-terminated bearer can an SRB (e.g., SRB) or a DRB.

FIG. 3 is a messaging diagram of an example scenario 300 in which the UE 102 generates and transmits a BSR to the base station 104.

First, the base station 104 transmits 310 a configuration to the UE 102. This configuration also can be referred to as the first message, and can be for example an RRC message. As a more specific example, the first message can be RRCReconfiguration, RRCSetup, RRCReestablishment, RRC re-establishment, RRCResume. In other implementations, the base station 104 can broadcast the first message in the cell, in the form of system information (e.g. SIB). In still another implementation, the first message can be a MAC CE.

The first message can include an LCG configuration for the UE 102. For example, this configuration can pertain to LCG2. For clarity, the examples below continue to refer to LCG2.

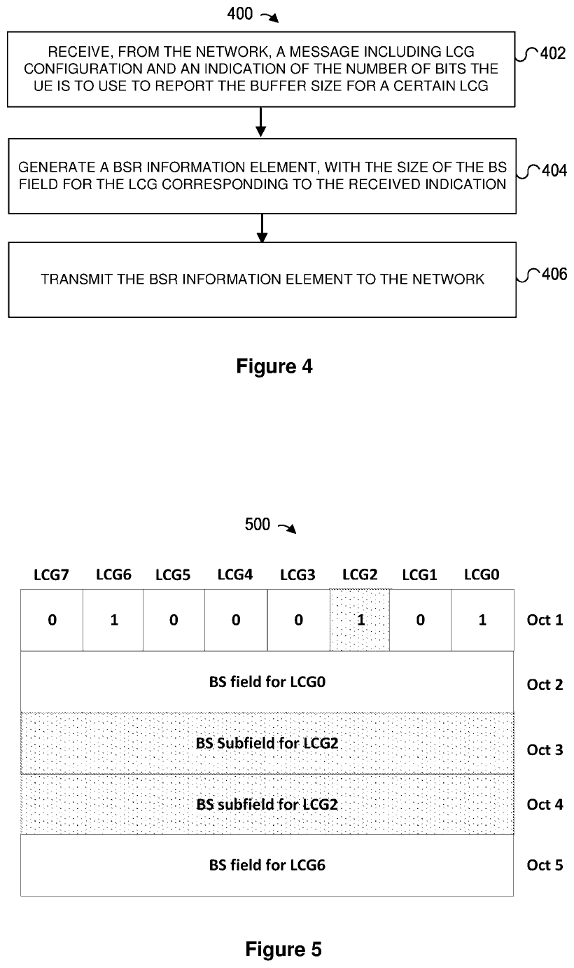

The UE 102 generates 320 a BSR MAC CE or another suitable information element, as discussed below with reference to FIGS. 4-9C. The UE 102 transmits 330 the BSR MAC CE to the base station 104. The base station 104 then processes 340 the BSR MAC CE.

Now referring to FIGS. 4-5, an example method 400 for reporting the buffer size for a certain LCG using the size of the field can be implemented in the UE 102. The network can indicate the size of the field. At block 402, the UE 102 receives a configuration for an LCG in a first message (e.g., event 310 discussed above). The first message indicates that the UE 102 is to use N bits to report buffer size for the LCG2. Any suitable number of bits can apply (e.g. 5 bits, 8 bits, 16 bits, 32 bits or 64 bits), but FIG. 5 illustrates the use of 16 bits for ease of explanation.

At block 404, the UE 102 can set the LCG2 field in the BSR MAC CE to “1” and add a 16-bit BS field for the LCG2, as illustrated in FIG. 5. In particular, the UE 102 can set the 16-bit BS field to an index of a buffer size as listed in the buffer size table. At block 406, the UE 102 transmits the BSR MAC CE to the base station 104 (see event 330).

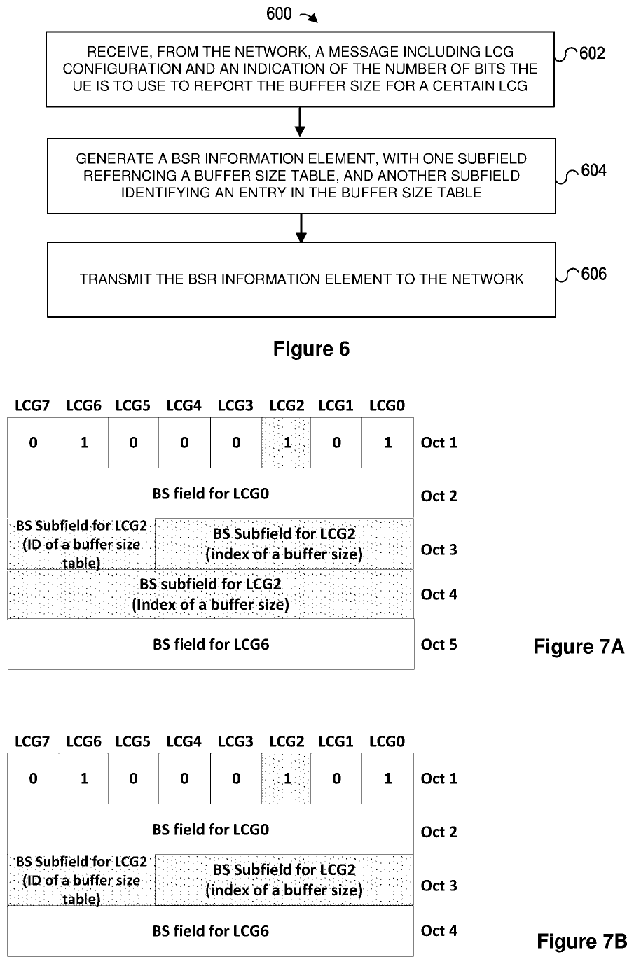

FIG. 6 is a flow diagram of an example method 600 for reporting the buffer size for a certain LCG using one subfield to reference a particular buffer size table, and another subfield to reference a particular entry in the table.

As illustrated in FIG. 6 and FIG. 7A, the UE 102 at block 604 divides the 16-bit BS field into sub-fields. The UE 102 uses one of the subfields to indicate one of buffer size tables, and uses another subfield as an index to the buffer size entry in the indicated buffer size table. For example, three bits can indicate a buffer size table, and 13 bits can indicate an index in the buffer size table.

As illustrated in FIG. 7B, when the BS field consists of 8 bits, the UE 102 also divides the 8 bits into sub-fields. One of the subfields indicates one of buffer size tables, and another subfield operates an index to a buffer size in the indicated buffer size table.

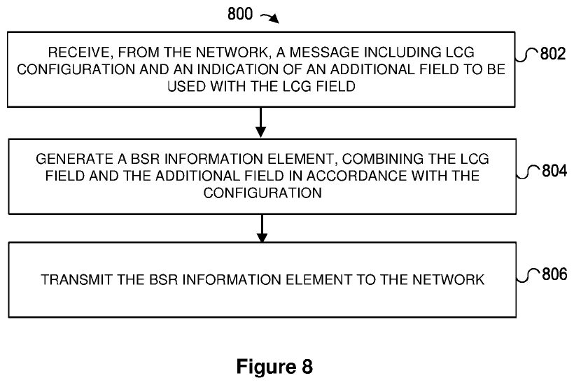

FIG. 8 is a flow diagram of an example method 800 for reporting the buffer size for a certain LCG using multiple subfields to reference respective entries in the buffer size table, where the desired buffer size is a function of the two entries. At block 802, the UE 102 receives a configuration for an LCG in a first message (e.g., event 310 discussed above).

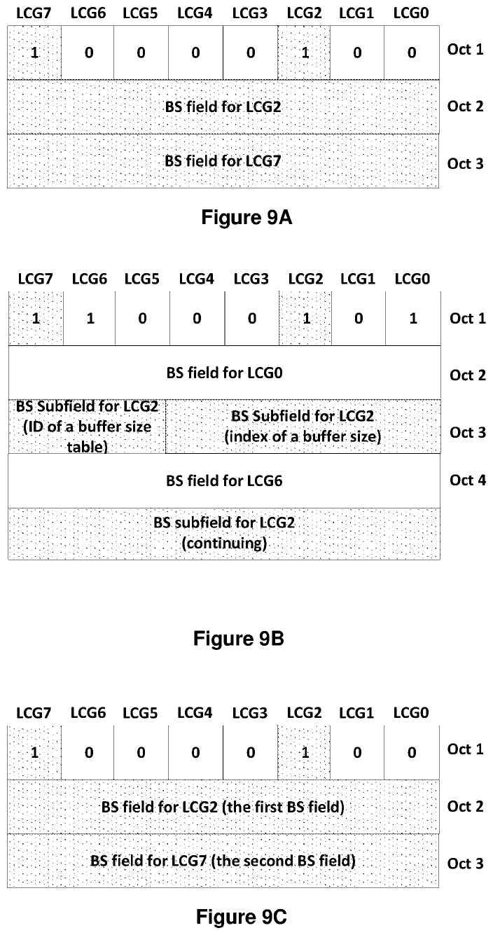

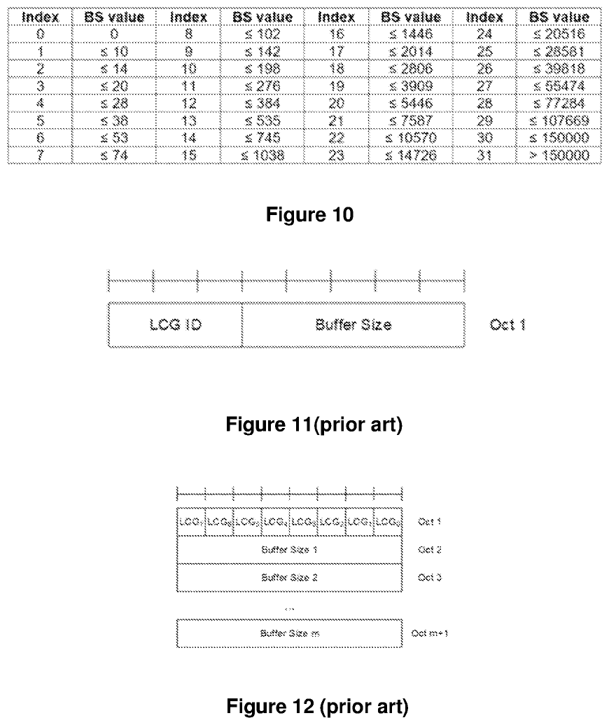

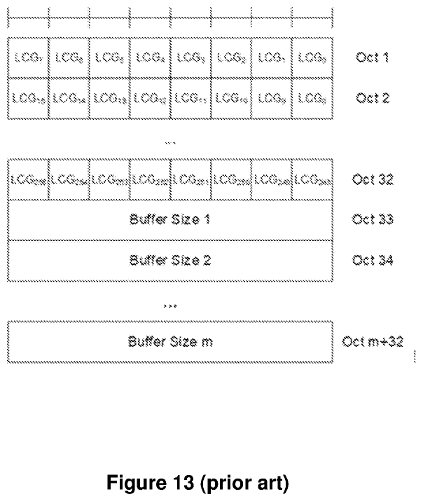

The first message in this example associates the LCG2 with another LCG field in the BSR MAC CE. In the example illustrates in FIGS. 9A-C, the other field is the LCG7 field. The base station 104 in this example scenario has not configured the UE 102 with the logical channel group 7, or LCG 7. Thus, the UE does not use LCG 7 in this scenario.

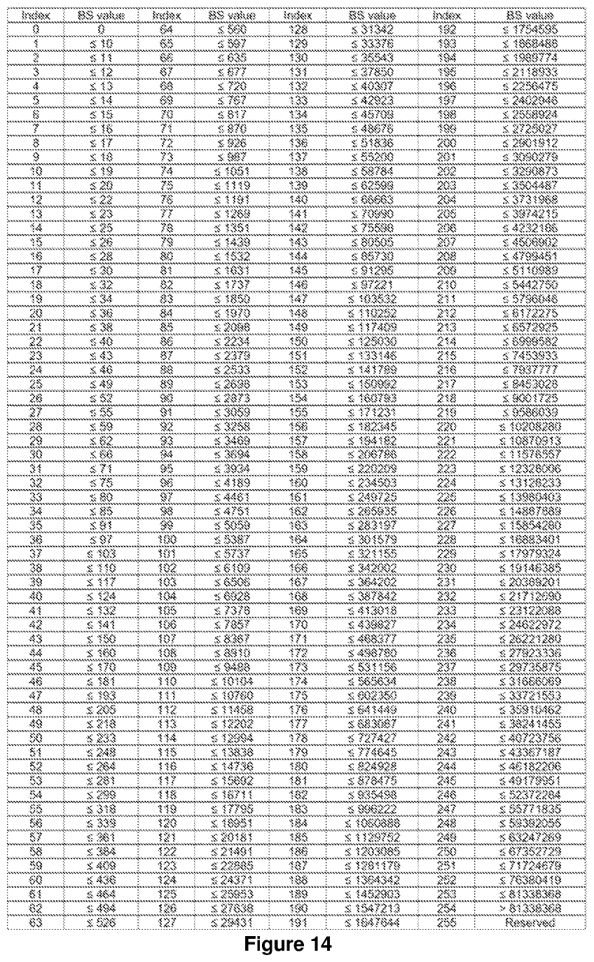

LCG2 can correspond to the LCG2 field in the BSR MAC CE by default. In addition to the LCG2 field, the base station 104 and the UE 102 further associate LCG2 with the LCG7 field. This allows the UE 102 to dynamically add an 8-bit BS field (see FIG. 14, for example) to the BSR MAC CE. Unlike another possible technique, according to which the UE 102 reports the buffer size for LCG2 by setting the LCG2 field to “1” and adding a BS field corresponding to the LCG2 field, here the UE 102 also sets LCG7 field to 1 and adds a BS field corresponding to the LCG7. These two BS fields together provide the buffer status information for LCG2.

In some cases, one BS field is sufficient to signal the buffer status; in other cases, however, the UE 102 uses two BS fields to signal the buffer status. This dynamic feature reduces the BSR signaling overhead. Notably, the additional field need not be LCG7 or another already-defined field. For example, the UE 102 and the base station 104 can use a dedicated field that signals the presence of the second BS field. In this scenario, reusing the LCG7 field, which the UE 102 and the base station 104 here do not use for the LCG7-related purposes, further reduces the signaling overhead.

At block 804, the UE 102 sets the LCG 2 field to “1” and adds a first BS field for the LCG2. The UE 102 also sets LCG7 field to “1” and adds a second BS field. If the UE 102 does not need to add a second BS field, the UE 102 sets the LCG 7 field to “0.”

As illustrated in FIG. 9A, the UE 102 can combine the first BS field and the second BS field to form a 16-bit BS field. For example, the first BS field can include the most/least significant bits, and the second BS field can include the less/most significant bits. The UE 102 can populate the 16-bit BS field as discussed above. The base station 104 can assign a threshold to the UE 102 in the first message (see event 310). When the buffer size of LCG 2 is larger than the threshold, the UE 102 can report a 16-bit BS field. Otherwise, the UE 120 can report a 8-bit BS field.

As illustrated in FIG. 9B, the UE 102 alternatively can use the two bytes for LCG2 as discussed above, but the first byte in this example contains a subfield indicating a buffer size table. The remaining bits and the second bytes form an index to the table.

FIG. 9C illustrates another example in which the UE 102 sets the first BS field to an index from the buffer size table. The index maps to a first maximum BS. The UE 102 sets the second BS field to another index from the buffer size table for 8-bit BS field. The index is mapped to a second max BS.

Referring back to event 340 in FIG. 3, the base station can receive the BSR MAC CE and use the BS field to look up the buffer size table and obtain the maximum BS for the LCG2 (if the implementation of FIG. 4 or FIG. 6 is used).

Alternatively, if the UE 102 implements the technique of FIG. 8, the base station 104 can receive the BSR MAC CE, detect that the LCG7 field is set to “1”, and determine knows that UE 102 has added the second BS field. The base station 104 then can use the first BS field and the second BS field to determine the max BS for LCG2.

In particular, the base station 104 can use the 16-bit BS field to look up the buffer size table for the max BS for the LCG2.

Alternatively, the base station 104 can derive the resulting maximum BS for LCG 2 according to the following formula:

$$Resulting maximum BS = the first max BS - the second max BS$$

For example, assuming the buffer size for LCG2 is 78M bytes, to report the buffer status, the UE 102 sets the LCG2 field to “1” and sets the first BS field to index 253 (i.e. max BS=81,338,368 bytes). The UE 102 also sets the LCG7 field to “1” and sets the second field to index 202 (i.e. max BS=3,290,873). When the base station 104 receives the BSR, the base station 104 computes the resulting max BS for LCG2 as 81,338,368−3,290,873=78,047,495. In this case, if base station 104 allocates resources to the UE 102 to transmit 78,047,495 bytes, only 47,495 bytes are not used to convey useful information (i.e., wasted), which is significantly less than 81,338,368−78000000=3,338,368 bytes.

If the base station 104 configures the UE 102 to add even more BS fields for LCG2, the waste of bytes can be further reduced. To continue with the example above, the base station 104 further configures the UE 102 with another indicator associated with LCG 6. Then the UE 102 can set BS field associated with LCG 6 to index 134 (i.e. max SB=45709). When the base station 104 receives the BSR, it determines that the resulting maximum BS is 81,338,368 (for index 253)−3,290,873 (for index 202)−45,709 (for index 134)=78,001,786. Thus, only 1786 bytes are wasted.

In another example, the base station 104 computes the resulting max BS with the following formula:

$$Resulting maximum BS = the first max BS + the second max BS$$

The base station 104 in some implementations configures the UE 102 to with the proper operator (addition, subtraction) in the first message.

The disclosure contemplates at least the following examples:
Example 1. A method in a user equipment (UE) for reporting a buffer status, the method comprising: receiving, at the UE from a network, an indication of a format the UE is to use to report, to the network, a buffer size for a logical channel group (LCG); generating, at the UE and in accordance with the format, a report of the buffer size of the LCG; and transmitting the report to the network.
Example 2. The method of example 1, wherein the indication of the format is a field size which the UE is to use to report the buffer size of the LCG.
Example 3. The method of example 2, wherein the field size is measured in bits.
Example 4. The method of example 2 or 3, wherein generating the report in accordance with the format includes: including, in a field having the field size, an index to a buffer size table, transmitting the field in the report.
Example 5. The method of example 2 or 3, wherein generating the report in accordance with the format includes: including, in a first sub-field, an indication of one of a plurality of buffer size tables, including, in a second sub-field, an index to the one of a plurality of buffer size tables; wherein a field having the field size consists of the first sub-field and the second sub-field.
Example 6. The method of example 1, wherein the indication of the format includes: a reference to an additional field which the UE is to use to report the buffer of the LCG, the additional field allocated for a second LCG not being used by the UE, the additional field allocated in an information element for specifying a plurality of buffer sizes for a plurality of respective LCGs.
Example 7. The method of example 6, wherein generating the report in accordance with the format includes: using a field allocated within the information element for the LCG as a first portion of a combined field for reporting the buffer size of the LCG, and using the additional field as a second portion of the combined field.
Example 8. The method of example 7, wherein generating the report in accordance with the format further includes: including, in a first sub-field of the combined field, an indication of one of a plurality of buffer size tables, and including, in a second sub-field of the combined field, an index to the one of a plurality of buffer size tables.
Example 9. The method of example 7, wherein generating the report in accordance with the format further includes: including, in a first sub-field of the combined field, a first index to a buffer size table, to specify a first buffer size value, and including, in a second sub-field of the combined field, a second index to the buffer size table, to specify a second buffer size value; wherein the buffer size of the LCG corresponds to a mathematical operation in which the first buffer size value is a first operand, and the second buffer size value is a second operand.
Example 10. The method of example 9, wherein the mathematical operation is addition.
Example 11. The method of example 9, wherein the mathematical operation is subtraction.
Example 12. The method of any of examples 7-11, wherein the field allocated for the LCG and the additional field are non-contiguous within the information element.
Example 13. The method of any of examples 7-11, wherein the field allocated for the LCG and the additional field are contiguous within the information element.
Example 14. The method of any of the preceding examples, wherein the receiving of the indication of the format includes: receiving a configuration including a configuration for the LCG, the configuration including the indication of the format.
Example 15. The method of example 14, wherein the configuration is included in a Radio Resource Control (RRC) message addressed to the UE.
Example 16. The method of example 14, wherein the configuration is included in a system information block (SIB) message broadcast in a cell in which the UE currently operates.
Example 17. The method of any of the preceding examples, wherein generating the report includes: generating a Medium Access Control (MAC) Buffer Status Report (BSR) control element (CE).
Example 18. A user equipment (UE) comprising: a radio circuitry configured to support a radio interface; a control circuitry configured to implement a method according to any of the preceding examples.
Example 20. A method in a network for obtaining a buffer status of a UE, the method comprising: transmitting, to a UE, an indication of a format the UE is to use to report, to the network, a buffer size for a logical channel group (LCG); receiving, at the network from the UE, a report of the buffer size of the LCG, the UE generated in accordance with the format.
Example 21. The method of example 21, wherein the indication of the format is a field size which the UE is to use to report the buffer size of the LCG.
Example 22. The method of example 22, wherein the field size is measured in bits.
Example 23. The method of example 21 or 22, wherein receiving the report in accordance with the format includes: receiving, in a field having the field size, an index to a buffer size table, retrieving the buffer size from the buffer size table, based on the index.
Example 24. The method of example 21 or 22, wherein receiving the report in accordance with the format includes: receiving, in a first sub-field, an indication of one of a plurality of buffer size tables, and receiving, in a second sub-field, an index to the one of a plurality of buffer size tables; wherein a field having the field size consists of the first sub-field and the second sub-field.
Example 25. The method of example 20, wherein the indication of the format includes: a reference to an additional field which the UE is to use to report the buffer of the LCG, the additional field allocated for a second LCG not being used by the UE, the additional field allocated in an information element for specifying a plurality of buffer sizes for a plurality of respective LCGs.
Example 26. The method of example 26, wherein receiving the report in accordance with the format includes: using a field allocated within the information element for the LCG as a first portion of a combined field for reporting the buffer size of the LCG, and using the additional field as a second portion of the combined field.
Example 27. The method of example 26, wherein receiving the report in accordance with the format further includes: receiving, in a first sub-field of the combined field, an indication of one of a plurality of buffer size tables, and receiving, in a second sub-field of the combined field, an index to the one of a plurality of buffer size tables.
Example 28. The method of example 27, wherein receiving the report in accordance with the format further includes: receiving, in a first sub-field of the combined field, a first index to a buffer size table, to specify a first buffer size value, and receiving, in a second sub-field of the combined field, a second index to the buffer size table, to specify a second buffer size value; wherein the buffer size of the LCG corresponds to a mathematical operation in which the first buffer size value is a first operand, and the second buffer size value is a second operand.
Example 29. The method of example 28, wherein the mathematical operation is addition.
Example 30. The method of example 28, wherein the mathematical operation is subtraction.
Example 31. The method of any of examples 26-30, wherein the field allocated for the LCG and the additional field are non-contiguous within the information element.
Example 32. The method of any of examples 26-30, wherein the field allocated for the LCG and the additional field are contiguous within the information element.
Example 33. The method of any of examples 20-32, wherein the transmitting of the indication of the format includes: transmitting a configuration including a configuration for the LCG, the configuration including the indication of the format.
Example 34. The method of example 33, wherein the configuration is included in a Radio Resource Control (RRC) message addressed to the UE.
Example 35. The method of example 33, wherein the configuration is included in a system information block (SIB) message broadcast in a cell in which the UE currently operates.
Example 36. The method of any of examples 20-35, wherein receiving the report includes: receiving a Medium Access Control (MAC) Buffer Status Report (BSR) control element (CE).
Example 37. A network device comprising: a radio circuitry configured to support a radio interface; a control circuitry configured to implement a method according to any of examples 20-36.

The following description may be applied to the description above.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, the “configuration activation command” can be replaced by “serving cell change command”, “Layer 1/Layer 2 switching command”, “lower layer switching command” or “lower layer serving cell change command”. The “fast serving cell configuration procedure” can be replaced by “fast serving cell change procedure”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for handling mobility between base stations through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method in a user equipment (UE) for reporting a buffer status, the method comprising:
receiving, at the UE from a network, an indication of a format the UE is to use to report, to the network, a buffer size for a logical channel group (LCG);
generating, at the UE and in accordance with the format, a report of the buffer size of the LCG, the report including (i) an indication of one of a plurality of buffer size tables, and (ii) an index in the one of the plurality of buffer size tables; and
transmitting the report to the network.

2. The method of claim 1, wherein the indication is less than one byte.

3. The method of claim 2, wherein the indication is transmitted in a byte that includes at least one other field containing information for the network.

4. The method of claim 1, further comprising:
determining whether the buffer size for the LCG is greater than a threshold value; and
selecting the format in view of the determining.

5. The method of claim 4, further comprising:
using a first number of bits for the index in response to determining that the buffer size for the LCG is greater than the threshold value; and
using a second number of bits for the index in response to determining that the buffer size for the LCG is not greater than the threshold value.

6. The method of claim 4, wherein the threshold value is assigned by the network.

7. The method of claim 1, wherein generating the report includes:
generating a Medium Access Control (MAC) Buffer Status Report (BSR) control element (CE).

8. The method of claim 1, wherein the indication of the format is included in a Radio Resource Control (RRC) message addressed to the UE.

9. The method of claim 1, wherein the indication of the format is included in a system information block (SIB) message broadcast in a cell in which the UE currently operates.

10. The method of claim 1, wherein the receiving of the indication of the format includes:
receiving, from the network, a message including a configuration for the LCG and indication of an additional field to be used with an LCG field corresponding to the LCG.

11. A method in a network for obtaining a buffer status of a UE, the method comprising:
transmitting, to a UE, an indication of a format the UE is to use to report, to the network, a buffer size for a logical channel group (LCG);
receiving, at the network from the UE, a report of the buffer size of the LCG, the UE generated in accordance with the format and including (i) an indication of one of a plurality of buffer size tables, and (ii) an index in the one of the plurality of buffer size tables.

12. The method of claim 11, wherein the indication is less than one byte.

13. The method of claim 12, wherein the indication is transmitted in a byte that includes at least one other field containing information for the network.

14. The method of claim 1, further comprising:
assigning, to the UE, a threshold value for determining the format in view of a buffer size.

15. A device comprising:
a radio circuitry configured to support a radio interface;
a control circuitry; the device configured to:
receive, at the UE from a network, an indication of a format the UE is to use to report, to the network, a buffer size for a logical channel group (LCG),
generate, at the UE and in accordance with the format, a report of the buffer size of the LCG, the report including (i) an indication of one of a plurality of buffer size tables, and (ii) an index in the one of the plurality of buffer size table, and
transmit the report to the network.

16. The device of claim 15, wherein the indication is less than one byte.

17. The device of claim 16, wherein the indication is transmitted in a byte that includes at least one other field containing information for the network.

18. The device of claim 15, further configured to:
determine whether the buffer size for the LCG is greater than a threshold value; and
select the format in view of the determining.

19. The device of claim 18, further configured to:
use a first number of bits for the index in response to determining that the buffer size for the LCG is greater than the threshold value; and
use a second number of bits for the index in response to determining that the buffer size for the LCG is not greater than the threshold value.

20. The device of claim 18, wherein the threshold value is assigned by the network.
